(19) United States
(12) Patent Application Publication
(10) Pub. No.: US 2025/0381874 A1
(43) Pub. Date: Dec. 18, 2025

(54) BATTERY-ENABLED, DIRECT CURRENT, ELECTRIC VEHICLE CHARGING STATION, METHOD AND CONTROLLER THEREFOR

(71) Applicant: eCamion Inc., Toronto (CA)

(72) Inventors: Carmine N. Pizzurro, Toronto (CA); Himanshu Sudan, Toronto (CA); Richard W. Szymczyk, Toronto (CA); Youhan Fu, Toronto (CA); Reza Iravani, Toronto (CA); Mostafa Mahfouz, Toronto (CA)

(21) Appl. No.: 19/016,838

(22) Filed: Jan. 10, 2025

Related U.S. Application Data
(63) Continuation of application No. 17/465,295, filed on Sep. 2, 2021, now abandoned.
(60) Provisional application No. 63/117,986, filed on Nov. 24, 2020.

(51) Int. Cl. B60L 53/62; B60L 8/00; B60L 58/13; B60L 58/14; B60L 58/15; H02J 3/32; H02J 3/38; H02J 7/00; H02M 3/335

(52) U.S. Cl. CPC B60L 53/62; B60L 8/003; B60L 8/006; B60L 58/13; B60L 58/14; B60L 58/15; H02J 3/32; H02J 3/381; H02J 7/00302; H02J 7/00306; H02J 7/0048; H02J 7/00712; H02J 2300/26; H02J 2300/28; H02M 3/33573

(57) ABSTRACT

An electric vehicle charging station comprises a direct current (DC) bus configured to receive DC power from multiple power sources including at least one battery energy storage system (BESS); at least one electric vehicle charging stall connected to the DC bus and configured to charge an electric vehicle load; and a controller configured to monitor and control power flow from the DC bus to the at least one electric vehicle charging stall and to monitor and control power flow between the BESS and the DC bus.

### CROSS-REFERENCE TO RELATED APPLICATION

This application is a Continuation of U.S. patent application Ser. No. 17/465,295, filed Sep. 2, 2021, and titled BATTERY-ENABLED, DIRECT CURRENT, ELECTRIC VEHICLE CHARGING STATION, METHOD AND CONTROLLER THEREFOR, which claims the benefit of U.S. Provisional Application No. 63/117,986 filed on Nov. 24, 2020, the entire content of which is incorporated herein by reference.

### FIELD

The subject disclosure relates to a battery-enabled, direct current, electric vehicle charging station and method and a controller therefor.

### BACKGROUND

Climate change has become an increasingly more popular topic and with it, a push has been made on many fronts to reduce reliance on fossil fuels and move to sources of cleaner “green” energy. Not surprisingly, in view of this push the introduction of electric vehicles has been embraced by both individual consumers and industry.

One major challenge to large-scale adoption of electric vehicles (EVs), electric fleets, and electric trucks is the lack of fast-charging infrastructure, particularly on long routes between cities and in rural areas. This restricts use of EVs and creates range anxiety, which in turn slows EV utilization and prevents environmental benefits from large-scale EV adoption.

Legacy weak, alternating current (AC) distribution grids generally hinder the adoption of EV fast-charging stations, rendering the simultaneous operation of multiple EV fast-charging stations infeasible. A typical weak AC distribution grid is characterized by low Short Circuit Level MVA_{sc} and low X/R-ratio. The limited capacity of weak AC distribution grids is another bottleneck since EV fast-charging stations require high power, e.g., up to 400 kW, as per CHAdeMO V2.0 protocol. Thus, integrating EV fast-charging stations into weak AC distribution grids can result in protection system issues, and steady-state voltage/frequency regulation problems. Moreover, the intermittent and fast load changes associated with fast-charging of EVs give rise to dynamic voltage regulation problems.

As will be appreciated, there exists a need for an electric vehicle fast-charging, direct current (DC) architecture to address the above issues. It is therefore an object to provide a novel battery-enabled, direct current, electric vehicle charging station and method and a novel controller therefor.

This background serves only to set a scene to allow a person skilled in the art to better appreciate the following detailed description. None of the above discussion should necessarily be taken as an acknowledgment that this discussion is part of the state of the art or is common general knowledge.

### BRIEF DESCRIPTION

It should be appreciated that this brief description is provided to introduce a selection of concepts in a simplified form that are further described below in the detailed description. This brief description is not intended to be used to limit the scope of claimed subject matter.

Accordingly, in one aspect there is provided an electric vehicle charging station comprising: a direct current (DC) bus configured to receive DC power from multiple power sources including at least one battery energy storage system (BESS); at least one electric vehicle charging stall connected to the DC bus and configured to charge an electric vehicle load; and a controller configured to monitor and control power flow from the DC bus to the at least one electric vehicle charging stall and to monitor and control power flow between the BESS and the DC bus.

In one or more embodiments, the controller is configured to monitor the state of charge and charging power of the BESS. In one form, the controller is configured to inhibit the BESS from violating maximum and minimum state of charge limits. In one form, the controller is configured to inhibit charge and discharge rates of the BESS from violating defined charge and discharge rate limits. In this case, the controller is configured to limit power draw of the at least one electric vehicle charging stall from the DC bus during charging of an electric vehicle load in response to determined BESS operating conditions that violate the minimum state of charge and/or discharge rate limits. The controller is also configured to limit power draw of the BESS from the DC bus during charging of the BESS in response to determined BESS operating conditions that violate the maximum state of charge and/or charge rate limits.

In one or more embodiments, the electric vehicle charging station comprises a plurality of electric vehicle charging stalls, and the controller is configured to monitor and control power flow from the DC bus to each electric vehicle charging stall. In one form, the controller is configured to limit power draw of each electric vehicle charging stall from the DC bus during charging of electric vehicle loads in response to determined BESS operation conditions that violate the minimum state of charge and/or discharge rate limits. The controller is also configured to limit power draw of the BESS from the DC bus during charging of the BESS in response to determined BESS operating conditions that violate the maximum state of charge and/or charge rate limits.

In one or more embodiments, the multiple power sources further comprise at least one renewable energy source. In one form, the at least one renewable energy source comprises at least one solar power and/or wind power source. In this case, the controller is configured to monitor and control power flow from the at least one renewable energy source to the DC bus. The controller may be configured to communicate with at least one DC to DC converter connecting the at least one renewable energy source to the DC bus.

In one or more embodiments, the multiple power sources further comprise an alternating current (AC) distribution grid. In one form, the controller is configured to monitor and control power flow between the AC distribution grid and the DC bus.

According to another aspect there is provided a method comprising: monitoring power on a DC bus supplied by multiple sources; monitoring a charging demand from at least one electric vehicle charging stall connected to the DC bus and configured to charge an electric vehicle load; discharging power from a battery energy storage system (BESS) to the DC bus when the power on the DC bus is unable to meet the charging demand; and inhibiting the BESS from violating at least one defined operating condition during the power discharging.

In one or more embodiments, the at least one defined operating condition comprises a minimum state of charge of the BESS. In one form, the at least one defined operating condition further comprises a maximum discharge rate of the BESS.

In one or more embodiments, the inhibiting comprises curtailing power supplied to the electric vehicle load.

In one or more embodiments, the method further comprises discharging power from the DC bus to the BESS when power on the DC bus exceeds the charging demand. In one form, the at lest one defined operating condition further comprises a maximum state of charge of the BESS. In another form, the at least one defined operating condition further comprises maximum charge rate of the BESS.

In one or more embodiments, the method further comprises discharging power from at least one renewable power source to the DC bus. In one form, the inhibiting comprises curtailing power supplied to the DC bus by the at least one renewable power source.

### BRIEF DESCRIPTION OF THE DRAWINGS

Embodiments will now be described more fully with reference to the accompanying drawings in which:

FIG. 1 is a schematic diagram of a multi-input, multi-output (MIMO) electric vehicle charging station;

FIG. 2 is a circuit diagram showing components of the MIMO electric vehicle charging station of FIG. 1;

FIGS. 3(a) to 3(e) are state transition diagrams of discrete event system (DES) models of electric vehicle charging stalls, a solar power source, a voltage source converter, and a battery energy storage system forming part of the MIMO electric vehicle charging station of FIG. 1; and

FIG. 4 shows the operational logic of a controller of the MIMO electric vehicle charging station of FIG. 1 in response to battery energy storage system status signals.

### DETAILED DESCRIPTION

The foregoing brief description, as well as the following detailed description of certain examples will be better understood when read in conjunction with the accompanying drawings. As used herein, a feature, structure, element, component etc. introduced in the singular and preceded by the word “a” or “an” should be understood as not necessarily excluding the plural of the features, structures, elements, components etc. Further, references to “one example” or “one embodiment” are not intended to be interpreted as excluding the existence of additional examples or embodiments that also incorporate the described features, structures, elements, components etc.

Unless explicitly stated to the contrary, examples or embodiments “comprising” or “having” or “including” a feature, structure, element, component etc. or a plurality of features, structures, elements, components etc. having a particular property may include additional features, structures, elements, components etc. not having that property. Also, it will be appreciated that the terms “comprises”, “has”, “includes” means “including but not limited to” and the terms “comprising”, “having” and “including” have equivalent meanings.

As used herein, the term “and/or” can include any and all combinations of one or more of the associated listed features, structures, elements, components or other subject matter.

It will be understood that when a feature, structure, element, component etc. is referred to as being “on”, “attached” to, “affixed” to, “connected” to, “coupled” with, “contacting”, etc. another feature, structure, element, component etc. that feature, structure, element, component etc. can be directly on, attached to, connected to, coupled with or contacting the feature, structure, element, component etc. or intervening features, structures, elements, components etc. may also be present. In contrast, when a feature, structure, element, component etc. is referred to as being, for example, “directly on”, “directly attached” to, “directly affixed” to, “directly connected” to, “directly coupled” with or “directly contacting” another feature, structure, element, component etc. there are no intervening features, structures, elements, components etc. present.

It will be understood that spatially relative terms, such as “under”, “below”, “lower”, “over”, “above”, “upper”, “front”, “back” and the like, may be used herein for ease of description to describe the relationship of a feature, structure, element, component etc. to another feature, structure, element, component etc. as illustrated in the figures. The spatially relative terms can however, encompass different orientations in use or operation in addition to the orientation depicted in the figures.

Reference herein to “example” means that one or more feature, structure, element, component, characteristic and/or operational step described in connection with the example is included in at least one embodiment and/or implementation of the subject matter according to the subject disclosure. Thus, the phrases “an example,” “another example,” and similar language throughout the subject disclosure may, but do not necessarily, refer to the same example. Further, the subject matter characterizing any one example may, but does not necessarily, include the subject matter characterizing any other example.

Reference herein to “configured” denotes an actual state of configuration that fundamentally ties the feature, structure, element, component, or other subject matter to the physical characteristics of the feature, structure, element, component or other subject matter preceding the phrase “configured to”. Thus, “configured” means that the feature, structure, element, component or other subject matter is designed and/or intended to perform a given function. Thus, the use of the term “configured” should not be construed to mean that a given feature, structure, element, component, or other subject matter is simply “capable of” performing a given function but that the feature, structure, element, component, and/or other subject matter is specifically selected, created, implemented, utilized, and/or designed for the purpose of performing the function. Subject matter that is described as being configured to perform a particular function may additionally or alternatively be described as being operative to perform that function.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of a lower-numbered item (e.g., a “first” item) and/or a higher-numbered item (e.g., a “third” item).

As used herein, the terms “approximately”, “about”, “substantially”, “generally” etc. represent an amount or condition close to the stated amount or condition that results in the desired function being performed or the desired result being achieved. For example, the terms “approximately”, “about”, “substantially”, “generally” etc. may refer to an amount or condition that is within engineering tolerances to the precise valve or condition specified that would be readily appreciated by a person skilled in the art.

In general, an electric vehicle charging station is described that comprises a direct current (DC) bus configured to receive DC power from multiple power sources including at least one battery energy storage system (BESS). At least one electric vehicle charging stall is connected to the DC bus and is configured to charge an electric vehicle load. A controller is configured to monitor and control power flow from the DC bus to the at least one electric vehicle charging stall and to monitor and control power flow between the BESS and the DC bus. Further specifics concerning an exemplary electric vehicle charging station will now be described.

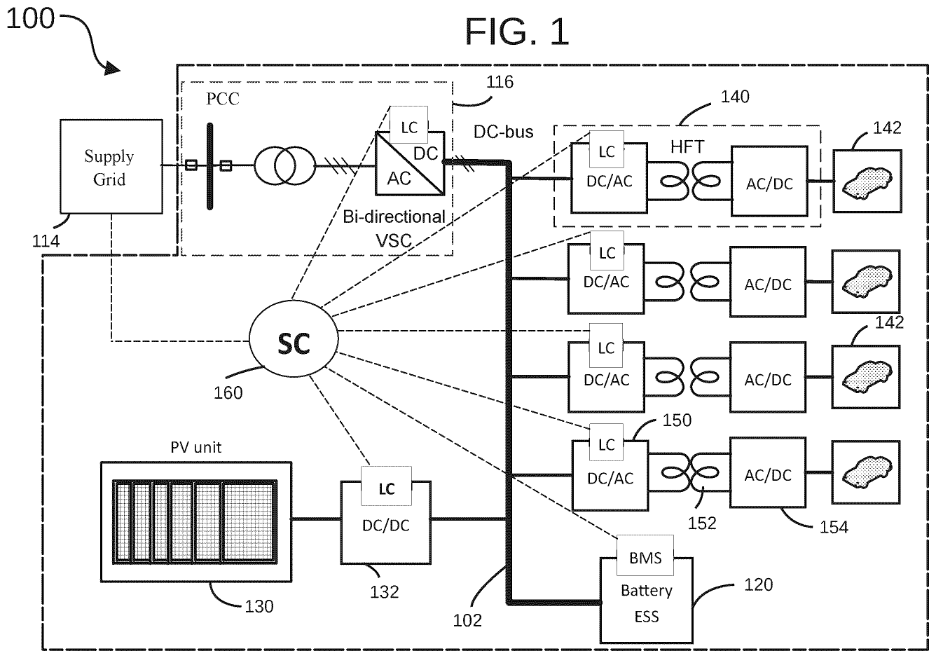

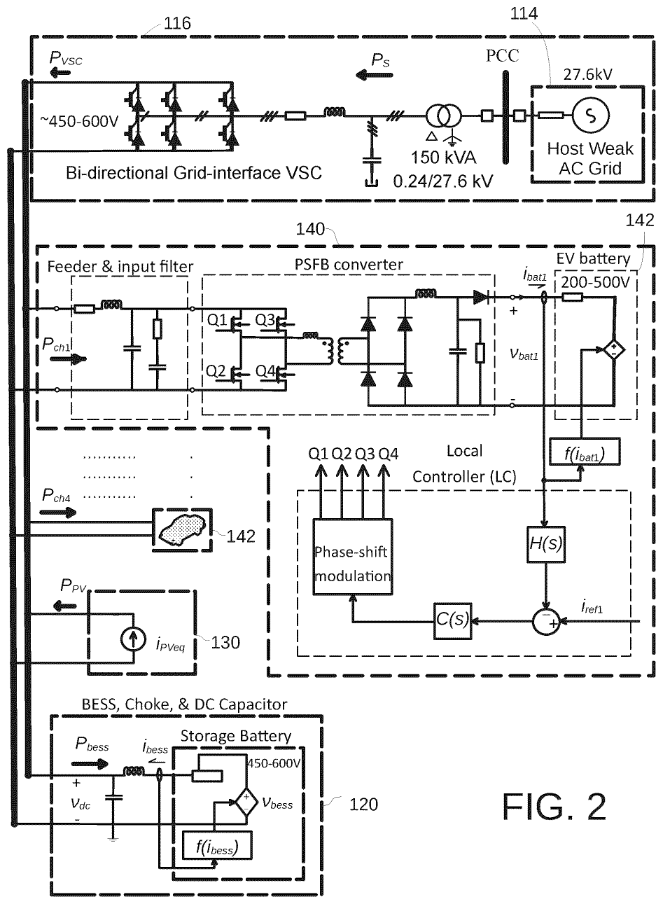

Turning now to FIGS. 1 and 2, a multi-input, multi-output (MIMO) electric vehicle charging station, center, depot etc. (hereinafter referred to as “station”) is shown and is generally identified by reference numeral 100. In this embodiment, the MIMO electric vehicle charging station 100 comprises a common direct current (DC) bus 102 that receives power from multiple sources of power and that provides power to electric vehicle charging equipment of electric vehicle charging stalls to allow electric vehicles to be charged quickly as will be described.

In the embodiment shown, the common DC bus 102 is connected to three (3) separate sources of power. Those of skill in the art will appreciate however that the common DC bus 102 may receive power from more or fewer sources of power. In this example, the common DC bus 102 is connected to a three-phase alternating current (AC) utility grid 114 via a feeder station 116. The feeder station 116 comprises, for example, circuit breakers and contactors, a static VAR compensator, a transformer, and a three-phase, bi-directional voltage source converter (VSC). As is known to those of skill in the art, the circuit breakers open automatically during unsafe conditions to electrically isolate the feeder station 116 from the utility grid 114. The contactors can be controlled manually or automatically to isolate the feeder station 116 from the utility grid 114. The static VAR compensator is configured to filter harmonics, regulate the output voltage, and control the power factor to keep the power factor close to unity. During power delivery from the utility grid 114 to the common DC bus 102, the transformer steps down the AC voltage received from the utility grid 114 to the required voltage (e.g. 600V) and the bi-directional VSC converts the AC power to DC power for supply to the common DC bus 102. During power delivery from the common DC bus 102 to the utility grid 114, the bi-directional VSC converter converts DC power on the common DC bus 102 to AC power and the transformer steps up the AC voltage to the required voltage for supply to the utility grid 114.

The common DC bus 102 is connected to a battery energy storage system (BESS) 120 that comprises a bank of rechargeable batteries and/or other energy storage devices and a battery management system (BMS). The BMS is configured to monitor the state of charge and charging power of the BESS and provide BESS operating condition signal output. BESS 120 is configured to deliver DC power to the common DC bus 102 when insufficient DC power levels on the common DC bus 102 are detected thereby to stabilize power on the common DC bus 102. BESS 120 is also configured to draw DC power from the common DC bus 102 when excess DC power is on the common DC bus 102 allowing the BESS 120 to charge.

Depending on the geographical location of the MIMO electric vehicle charging station 100, the common DC bus 102 may also be connected to one or more other sources of power such as renewable power sources e.g. solar power farms, wind power farms etc. For example as shown in FIG. 1, the common DC bus 102 is connected to a solar power source 130 comprising one or more solar panel arrays via a DC to DC converter 132. The DC to DC converter 132 is configured to ensure the DC output of the solar power source 130 is at the required voltage for supply to the common DC bus 102.

The common DC bus 102 is also connected to a plurality of electric vehicle charging stalls or slots 140. Each electric vehicle charging stall 140 is configured to provide power to an electric vehicle load 142 engaged therewith to facilitate charging of electric cars, busses and/or trucks. As will be appreciated by those of skill in the art, depending on the type(s) of electric vehicle(s) that the electric vehicle charging stalls 140 are configured to charge, the electric vehicle interfaces of the electric vehicle charging stalls 140 may vary. In this embodiment, each electric vehicle charging stall 140 comprises a DC to AC converter 150, an intermediate high frequency transformer 152, and an AC to DC converter 154 that are connected in series. Each electric vehicle charging stall 140 is also configured to operate in either a full load (FLD) mode or in one of two distinct curtailment (LDC_{soc} or LDC_{dis}) modes depending on the state of the BESS 120 as will be described.

Although the MIMO electric vehicle charging station 100 is shown as having four (4) electric vehicle charging stalls 140, those of skill in the art will appreciate that this is for ease of illustration only. In a typical MIMO electric vehicle charging station 100, the MIMO electric vehicle charging station 100 will typically include more electric vehicle charging stalls 140 than shown with the number of the electric vehicle charging stalls 140 being selected to allow the desired number of vehicles expected to use the MIMO electric vehicle charging station 100 to be properly serviced. Of course if desired, the MIMO electric vehicle charging station 100 may have fewer electric vehicle charging stalls 140.

In this embodiment, the MIMO electric vehicle charging station 100 further comprises a controller 160 that communicates with local controllers LC of the feeder station 116, DC to DC converter 132, and electric vehicle charging stalls 140 as well as with the utility grid 114 and the BMS of the BESS 120. The controller 160 in this embodiment resides on a programmed computing device such as a host computer, server, programmable logic controller (PLC) or other suitable processing device. The programmed computing device comprises, for example, one or more processors, system memory (volatile and/or non-volatile memory), other non-removable or removable memory (e.g., a hard disk drive, RAM, ROM, EEPROM, CD-ROM, DVD, flash memory, etc.) and a system bus coupling the various computer components to the one or more processors.

The controller 160 is configured to estimate and control incoming power received from each renewable power source such as the solar power source 130, plan and assign a setpoint with respect to power exchange with the utility grid 114, plan and set the maximum power draw limits for each electric vehicle charging stall 140, and plan and adjust power draw from the BESS 120 or power supply to the BESS 120.

During operation, the controller 160 substantially continuously monitors the BESS 120 and controls connectivity of the BESS 120, solar power source 130 and utility grid 114 to the common DC bus 102 to allow the MIMO electric vehicle charging station 100 to meet electric vehicle charging demands.

The controller 160 takes on a supervisory role with respect to the various MIMO electric vehicle station components connected thereto. With respect to the BESS 120, the controller 160 is configured to receive the state of charge (SOC) and charging power signal output of the BMS and to protect the BESS 120 by enforcing its upper and lower states of charge and by limiting its maximum charge and discharge rates in response to determining the states (modes of operation) of the solar power source 130, the electric vehicle charging stalls 140 and the VSC of the feeder station 116.

With respect to the electric vehicle charging stalls 140, the controller 160 is configured to determine the operational mode of each electric vehicle charging stall 140 and to determine if each electric vehicle charging stall 140 is able to fully or partially meet its electric vehicle charging demands.

With respect to the solar power source 130, the controller 160 is configured to determine if the solar power source 130 is operating in a maximum power point tracking (MPPT) mode or a curtailment mode and to allow surplus power of the solar power source 130 to be exported to the utility grid 114 via the common DC bus 102 if permitted.

With respect to the utility grid 114, the controller 160 is configured to signal the feeder station 116 to adjust the direction and magnitude of active/reactive power exchange with the utility grid 114 based on whether power from the utility grid 114 is to be fed to the common DC bus 102 or whether power from the common DC bus 102 is to be fed to the utility grid 114. The controller 160 is also configured to command the feeder station 116 to provide ancillary services (if required/permitted) depending on feeder station status, e.g., reactive power compensation, grid-voltage/frequency support, and AC load-balancing/power factor (PF) correction/active-filtering.

The controller 160 is configured to monitor the power available from the solar power source 130, and the power exchanged between the MIMO electric vehicle charging station 100 and the utility grid 114, which is limited based on the technical limits of the AC utility grid at its point of connection with the feeder station 116. Power P_{PV} represents the power provided by the solar power source 130 to the common DC bus 120. Excess power, if any, that appears on the common DC bus 102 is utilized to charge the BESS 120 if the state of charge SOC of the BESS 120 is below its upper charge limit. If the net imported power on the common DC bus 102 (that is the power provided to the common DC bus 102 by the solar power source 130 and the power imported from the utility grid 114) does not meet the charging requirements of the electric vehicle charging stalls 140, (ΣP_{chi}), then the controller 160 signals the BMS of the BESS 120 causing the BESS to discharge power to the common DC bus 120 thereby to satisfy the charging power deficit, i.e., the BESS 120 dynamically provides power balance within the MIMO electric vehicle charging station 100. During this operation, to enforce the state of charge SOC limits of the BESS 120 and its maximum charge/discharge rates, the controller 160 continuously monitors the signal output of the BMS to determine the operational conditions of the BESS 120.

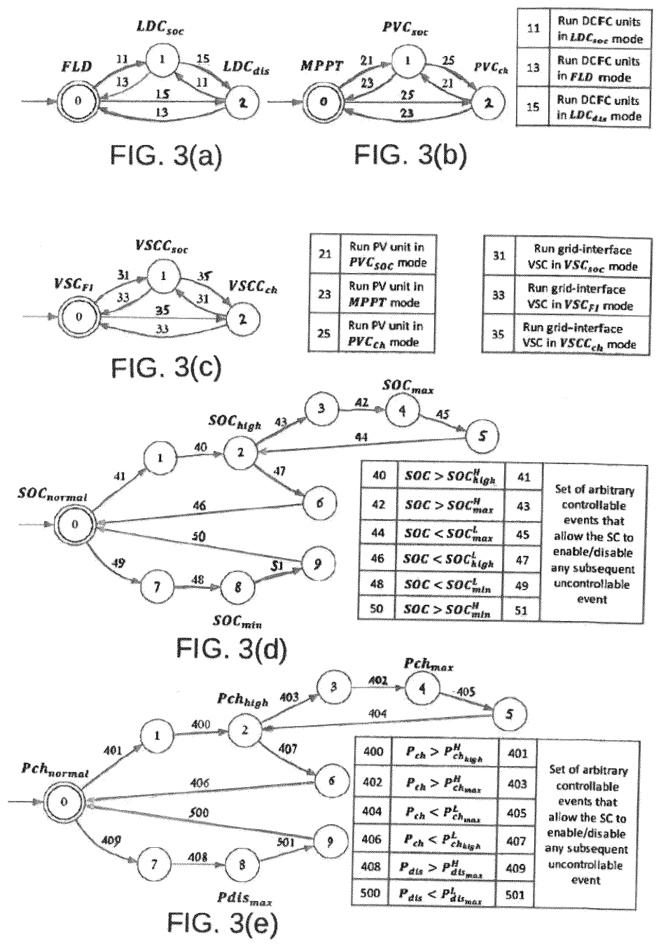

FIGS. 3(a) to 3(e) illustrate state transition diagrams of discrete event system (DES) models of the electric vehicle charging stalls 140, the solar power source 130, the feeder station 116, and the BESS 120. In particular, FIG. 3(a) shows that each electric vehicle charging stall 140 operates in either a full load (FLD) mode, i.e., marker state, or one of two distinct load curtailment LDC_{soc} or LDC_{dis} modes. In the FLD mode, the requested charging current (setpoint) of the electric vehicle load 142 is satisfied by the electric vehicle charging stall 140. That is, the electric vehicle charging stall 140 is able to meet its electric vehicle charging demands. In the LDC_{soc} mode, the controller 160 overrides the requested charging current of the electric vehicle load 142 and conditions the electric vehicle charging stall 140 to provide a lower charging current to the electric vehicle load 142 to meet state of charge constraints of the BESS 120 (i.e. when the state of charge of the BESS 120 reaches its lower limit). To avoid abrupt changes in the charging current supplied to the electric vehicle load 142, in the LDC_{soc} mode, the controller 160 conditions the electric vehicle charging stall 140 to ramp down the charging current provided to the electric vehicle load 142 to enforce charging power of the BESS 120 at a set rate. Once the set BESS charge rate is reached, the controller 160 holds the load curtailment signal. In the LDC_{dis} mode, the controller 160 overrides the requested charging current of the electric vehicle load 142 and conditions the electric vehicle charging stall 140 to provide a lower charging current to the electric vehicle load 142 to meet the discharge rate constraints of the BESS 120. In the LDC_{dis} mode, the controller 160 conditions the electric vehicle charging stall 140 to ramp down the charging current provided to the electric vehicle load 142 to enforce the BESS discharging power at its maximum rate P_{dismax}. As will be appreciated, the LDC_{soc} mode is more restrictive than the LDC_{dis} mode and can lead to full load shedding.

As can be seen from FIG. 3(b), the controller 160 is able to condition the solar power source 130 to either the MPPT mode, i.e., marker state, or to one of two distinct curtailment PVC_{soc} or PVC_{ch} modes. In the MPPT mode, the solar power source 130 delivers maximum power to the common DC bus 102 via the DC to DC converter 132 based on its MPPT algorithm. In the PVC_{soc} mode, the controller 160 conditions the DC to DC converter 132 to ramp down the power output of the solar power source 130 to the common DC bus 102 to enforce power discharging of the BESS 120 to the common DC bus 102 at a defined discharge rate (i.e. when the state of charge of the BESS 120 reaches its upper limit). Once the defined BESS discharge rate is reached, the controller 160 holds the solar power source curtailment signal. In the PVC_{ch} mode, the controller 160 conditions the DC to DC converter 132 to ramp down the power output of the solar power source 130 to the common DC bus 102 to enforce the charging power of the BESS 120 at its maximum rate. As will be appreciated, the PVC_{soc} mode is more restrictive than the PVC_{ch} mode and can lead to full curtailment of the solar power source 130.

As can be seen from FIG. 3 (c), the controller 160 operates the VSC of the feeder station 116 in either a full import (VSC_{FI}) mode, i.e., marker state, or one of two distinct VSC curtailment VSCC_{soc}, or VSCC_{ch} modes. In the VSC_{FI} mode, the controller 160 conditions the VSC to import predefined power from the utility grid 114 based on utility grid technical limitations at the point of connection of the feeder station 116 for applying to the common DC bus 102. In the VSCC_{soc} mode, the controller 160 conditions the VSC to curtail imported power to the common DC bus 102 or even to export power from the common DC bus 102 to the utility grid 114, in a ramped-fashion, with a specified ramp-rate, to maintain the state of charge SOC constraints of the BESS 120. In VSCC_{soc} mode, the controller 160 conditions the VSC to ramp down imported power to the common DC bus 102 to force the charging power of the BESS 120 to change its sign (i.e. to discharge) and reach a specified discharge power threshold. In the VSCC_{ch} mode, the controller 160 conditions the VSC to ramp down imported power to the common DC bus 102 to reduce the charging power of the BESS 120. Therefore, there is a higher chance to export excess power from the MIMO electric vehicle charging station 100 to the utility grid 114 without violating VSC ratings when the VSC of the feeder station 116 is in VSCC_{soc} mode and thus, the VSCC_{ch} mode is less restrictive than the VSCC_{soc} mode.

FIG. 3(d) shows the state transition diagram of the state of charge SOC of the BESS 120. Based on the state of charge SOC of the BESS 120, each discrete state among states 0, 2, 4, and 8 represents a status/condition of the BESS 120. The BESS 120 in state0 represents a normal state of charge condition (SOCₙₒᵣₘₐₗ) and signifies that the BESS 120 is operating within the normal state of charge SOC limits, i.e., marker state. The BESS 120 in state2 represents a state where the BESS is operating at higher than a specified state of charge SOC threshold (SOC_{high}) but in a state that is lower than the maximum permissible state of charge SOC. The BESS 120 in state4 represents a state where the state of charge SOC of the BESS is above the maximum permissible state of charge SOC. The BESS 120 in state8 represents a state where the state of charge SOC of the BESS 120 is below the minimum permissible state of charge SOC.

FIG. 3(e) shows the state transition diagram of power charging of the BESS 120, where discrete states numbered 0, 2, 4, and 8 represent Pₙₒᵣₘₐₗ, P_{chhigh}, P_{chmax}, and P_{dismax}, respectively. Pₙₒᵣₘₐₗ is the state where the BESS 120 charges/discharges at the normal charge/discharge rates, i.e., the marker state. P_{chhigh} is the state where the BESS 120 charges at higher than the specified charging-rate threshold but lower than the maximum permissible charge rate. In P_{chhigh}, the controller 160 permits curtailment of imported power to the common DC bus 102 from the feeder station 116. P_{chmax} indicates that the charging power of the BESS 120 is higher than the maximum charge rate. P_{dismax} indicates that the discharging power of the BESS 120 is higher than the maximum discharge rate.

FIGS. 3(d) and 3(e) also depict an arbitrary controllable event, e.g., 41, 43, . . . 51, 401, 403, . . . 501, that is introduced between two uncontrollable events. These events are to properly model the discrete behavior of the state of charge SOC and charge/discharge rate of the BESS 120 and account for possible actions of the controller 160 that enable/disable any subsequent uncontrollable event, e.g. 44 may not happen after 42 unless a controllable action(s), e.g., 21, is(are) taken.

The controller 160 is configured to allow surplus power from the solar power source 130 to be supplied to the common DC bus 102 via the DC to DC converter 130 and steadily exported to the utility grid 114 by maintaining the ramp rate of the utility grid power exchange at defined limits despite output power variability of the solar power source 130 and the variability of the electric vehicle loads on the electric vehicle charging stalls 140. Exporting of power from the solar power source 130 to the utility grid 114 can be prioritized by the controller 160 allowing for better utilization of renewable energy sources.

As will be appreciated, the discrete (logical) behaviour specification of the controller 160 is configured to:
(i) prevent curtailment of the solar power source 130 and electric vehicle charging stalls 140;
(ii) prevent simultaneous curtailment of the feeder station VSC and the electric vehicle charging stalls 140;
(iii) prioritize power export to the utility grid 114 over solar power source curtailment (i.e. not to curtail the solar power source 130 while the VSC is in the VSC_{FI} mode);
(iv) curtail utility grid imported power (VSC_{soc}) if the state of charge SOC of the BESS 120 exceeds SOC_{high};
(v) curtail utility grid imported power (VSCC_{cn}) if the charging power of the BESS 120 exceeds P_{chhigh};
(vi) curtail the solar power source 130 if the state of charge SOC of the BESS 120 violates its upper limit;
(vii) curtail the solar power source 130 if the charging power of the BESS violates its maximum rate;
(viii) curtail the electric vehicle charging stalls 140 if the state of charge SOC of the BESS 120 violates its lower limit;
(ix) curtail the electric vehicle charging stalls 140 if the discharge power of the BESS violates its maximum rate; and
(x) not take a control action unless an uncontrollable event occurs.

Since the state of charge of the BESS 120 and charging power of the BESS are independent physical quantities, the DES model of the BESS can be obtained from the synchronous product of the DESs of FIG. 3(d) and FIG. 3(e), respectively. The total number of possible discrete states and transitions for the BESS DES is 10×10=100 and 240.

The DESs of FIGS. 3(a) to 3(e) are synchronized to obtain the DES of the MIMO electric vehicle charging station 100. The discrete states of the VSC, electric vehicle charging stalls 140, solar power source 130, and BESS 120 are 3, 3, 3, and 100, respectively. The total number of possible discrete states and transitions for the MIMO electric vehicle charging station 100 are 3×3×3×100=2700 and 22680, respectively.

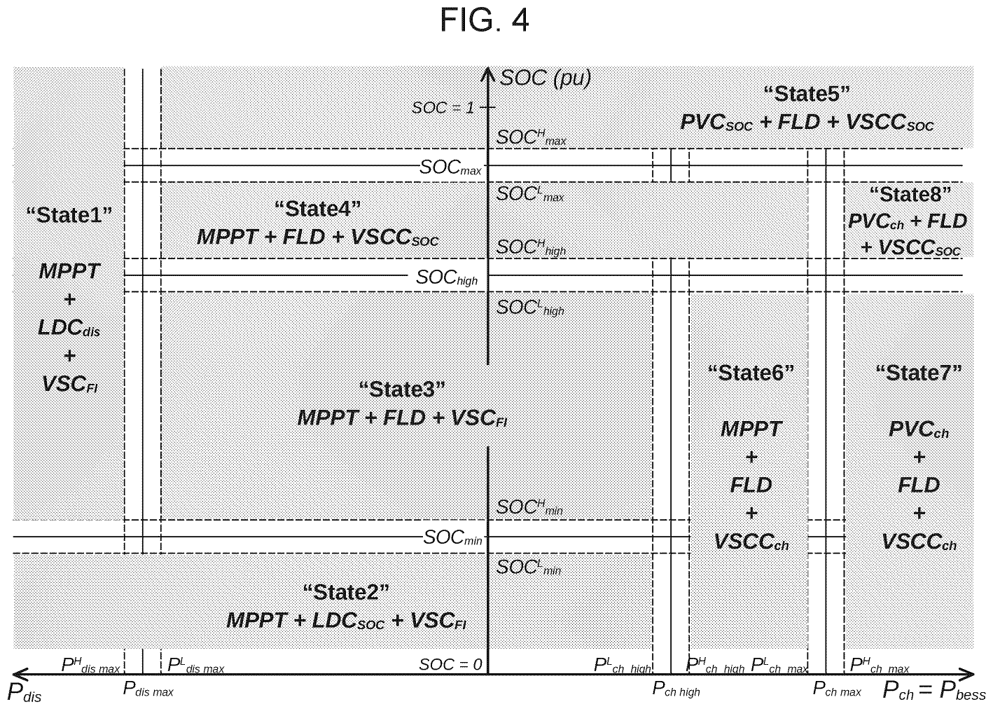

FIG. 4 shows the operational logic of the controller 160 of the MIMO electric vehicle charging station 100 in response to the state of charge SOC and charge/discharge rates of the BESS 120. As can be seen, the parameters SOCₘₐₓ, SOCₘᵢₙ, P_{chmax}, P_{dismax}, P_{chhigh}, and SOC_{high} and the width of the hysteresis bands are user-defined parameters. These limits can be defined as constant parameters or as dynamic limits, e.g., as a function of the ambient temperature, battery degradation, and power systems security considerations. The parameters SOCₘₐₓ, SOCₘᵢₙ, P_{chmax}, P_{dismax} are strict limits that the controller 160 enforces to protect the BESS 120. The parameters SOC_{high} and P_{chhigh} are design choices that depend on the sizes of the BESS 120 and the solar power source 130. These parameters can be viewed as reciprocals of the weighting factors for an optimization objective function, where the lower limits indicate higher capability to export power from the common DC bus 102 to the utility grid 114. As will be appreciated, the controller 160 operates based on supervisory control theory of discrete event systems in a manner to (i) be non-blocking, i.e. to prevent the MIMO electric vehicle charging station 100 from entering a deadlock scenario or collapse, and (ii) minimally restrict the discrete behaviour of the MIMO electric vehicle charging station 100 while allowing defined operating control settings to be met.

The operating points (i.e. state of charge and charge/discharging rates) of the BESS 120 can be visualized as a moving point in the two-dimensional plane of FIG. 4 where the controller 160 attempts to capture the point within the desirable region, i.e., state3 or marker state, by defining the modes of operation of the solar power source 130, the electric vehicle charging stalls 140, and the VSC of the feeder station 116.

As will be appreciated, the configuration and operation of the MIMO electric vehicle charging station 100 readily supports scalability allowing the number of electric vehicle charging stalls 140 and the sizes of the solar panel source 130 and BESS 120 to be increased as needed to support electric vehicle charging demand. The MIMO electric vehicle charging station 100 can be interfaced to legacy AC utility grids, irrespective of grid weakness and technical limits and can mitigate grid voltage regulation problems by limiting imported power to specified limits and confining electric vehicle charging dynamics.

Although embodiments have been described, those of skill in the art will appreciate that variations and modifications may be made without departing from the scope of the appended claims.

What is claimed is:

1. An electric vehicle charging station comprising:
a direct current (DC) bus configured to receive DC power from multiple power sources including at least one battery energy storage system (BESS);
a plurality of electric vehicle charging stalls connected to the DC bus, each electric vehicle charging stall being configured to charge an electric vehicle load connected thereto; and
a controller configured to monitor and control power flow from the DC bus to the electric vehicle charging stalls during electric vehicle load charging and to monitor and control power flow between the BESS and the DC bus,
wherein the controller is configured to monitor the state of charge and charging power of the BESS,
wherein the controller is configured to inhibit the BESS from violating maximum and minimum state of charge limits,
wherein the controller is configured to inhibit charge and discharge rates of the BESS from violating defined charge and discharge rate limits, and
wherein the controller, based on electric vehicle charging stall demands and state of charge constraints and discharge rate constraints of the BESS, is configured to curtail power draw to electric vehicle charging stalls from the DC bus during charging of electric vehicle loads to levels less than demand.

2. The electric vehicle charging station of claim 1, wherein the controller is configured to limit power draw of the BESS from the DC bus during charging of the BESS in response to determined BESS operating conditions that violate the maximum state of charge and/or charge rate limits.

3. The electric vehicle charging station of claim 1, wherein the multiple power sources further comprise at least one renewable energy source.

4. The electric vehicle charging station of claim 3, wherein the at least one renewable energy source comprises at least one solar power and/or wind power source.

5. The electric vehicle charging station of claim 3, wherein the controller is further configured to monitor and control power flow from the at least one renewable energy source to the DC bus.

6. The electric vehicle charging station of claim 5, wherein the controller is configured to communicate with at least one DC to DC converter connecting the at least one renewable energy source to the DC bus.

7. The electric vehicle charging station of claim 1, wherein the multiple power sources further comprise an alternating current (AC) distribution grid.

8. The electric vehicle charging station of claim 7, wherein the controller is configured to monitor and control power flow between the AC distribution grid and the DC bus.

9. The electric vehicle charging station of claim 1, wherein, to meet state of charge constraints of the BESS, the controller is configured to curtail power draw to the electric vehicle charging stalls from the DC bus during charging of electric vehicle loads by setting charging current to a set rate that is less than demand current rate.

10. The electric vehicle charging station of claim 9, wherein, to meet state of charge constraints of the BESS, the controller is configured to curtail power draw to the electric vehicle charging stalls from the DC bus during charging of electric vehicle loads by ramping down charging current to the set rate.

11. The electric vehicle charging station of claim 1, wherein, to meet discharge rate constraints of the BESS, the controller is configured to curtail power draw to the electric vehicle charging stalls from the DC bus during charging of electric vehicle loads by reducing charging current to a rate that is less than demand current rate.

12. The electric vehicle charging station of claim 11, wherein, to meet discharge rate constraints of the BESS, the controller is configured to curtail power draw to the electric vehicle charging stalls from the DC bus during charging of electric vehicle loads by ramping down charging current to the rate that is less than the demand current rate.

13. A method comprising:
monitoring power on a DC bus supplied by multiple sources;
monitoring a charging demand from at least one electric vehicle charging stall connected to the DC bus and configured to charge an electric vehicle load;
discharging power from a battery energy storage system (BESS) to the DC bus when the power on the DC bus is unable to meet the charging demand; and
based on the charging demand and to meet state of charge constraints and state of discharge constraints of the BESS during charging of the electric vehicle load, curtailing power draw to the electric vehicle load to a level less than the charging demand.

14. The method of claim 13, further comprising discharging power from the DC bus to the BESS when power on the DC bus exceeds the charging demand.

15. The method of claim 13, further comprising discharging power from at least one renewable power source to the DC bus.

16. The method of claim 15, further comprising curtailing power supplied to the DC bus by said at least one renewable power source.

17. The method of claim 13, wherein, to meet state of charge constraints of the BESS, the curtailing power draw to the electric vehicle load comprises setting charging current to a set rate that is less than demand current rate.

18. The method of claim 17, wherein, to meet state of charge constraints of the BESS, the curtailing power draw to the electric vehicle load comprises ramping down charging current to the set rate.

19. The method of claim 13, wherein, to meet discharge rate constraints of the BESS, the curtailing power draw to the electric vehicle load comprises reducing charging current to a rate that is less than demand current rate.

20. The method of claim 19, wherein to meet discharge rate constraints of the BESS, the curtailing power draw to the electric vehicle load comprises ramping down charging current to the rate that is less than the demand rate.
